(19) United States
(12) Patent Application Publication
(10) Pub. No.: US 2014/0372150 A1
(43) Pub. Date: Dec. 18, 2014

(54) SYSTEM AND METHOD FOR ADMINISTERING BUSINESS INSURANCE TRANSACTIONS USING CROWD SOURCED PURCHASING AND RISK DATA

(71) Applicant: Hartford Fire Insurance Company, Hartford, CT (US)

(72) Inventors: Derrick J. Karle, Wallingford, CT (US); Brian D. Waddell, West Hartford, CT (US)

(21) Appl. No.: 13/918,136

(22) Filed: Jun. 14, 2013

(51) Int. Cl. G06Q 40/08; G06Q 30/06

(52) U.S. Cl. CPC G06Q 40/08; G06Q 30/0631
USPC 705/4

(57) ABSTRACT

A data processing system for processing and selecting business insurance coverages is disclosed. The system uses crowd sourced data related to purchasing and risk concerns to correlate business owner requests for insurance recommendations in real time. Business owner policy configurations and options may be selectively tailored to a business owner based on the crowd sourcing data in a single or multi-insurer platform. Weather, economic and industry trend data may be used to configure appropriate business insurance recommendations.

### BACKGROUND

There are many thousands of different types of businesses being conducted in commerce every day and many new businesses being started each and every day. Each of these businesses has very specific needs, requirements, risks and demands. Consequently, insurance coverage products, coverages, limits, options and combinations thereof for such businesses also number in the many thousands. Coverage for small specialty trade contractors, midsize to large contractors, and construction wrap-up projects may be completely different than coverage for wide array of professional services including but not limited to accountants, advertising agencies, answering services, appraisers, business & management consultants, commercial property owners & managers, employment agencies, insurance agents, interior decorators, law firms, meeting planners, notary publics, photofinishing labs, public relations services, research organizations, secretarial & court reporting services, telemarketing firms, and travel agencies. Similarly insurance coverage for manufacturing based business such as printers & publishers, food processors, metal manufacturers, electronics manufacturers, plastics manufacturers, specialized truck equipment, auto parts manufacturers, and industrial equipment manufacturers will also differ greatly from service bases businesses. Generally, the new business owner does not have familiarity with the variety of business insurance products, coverages and options that they would need for their specific business and many times would greatly benefit from education from an expert as well as knowledge of what other similar businesses are purchasing and risk they are concerned with.

Generally, a business owner will want to have property coverage for their basic property. This type of coverage insures physical assets the business owns such as a building, equipment, furnishings, fixtures, inventory, computers, valuable papers, records, and more and can include personal property of others in the business' care, custody or control. Business income coverage is a type of property insurance that helps cover the loss of income resulting from a covered loss (such as a fire) that disrupts the operation of the business. This policy may also cover the expenses of operating a business from a secondary or remote site. Comprehensive General Liability (CGL) covers a company in the event that it causes certain harm to others, whether that harm is to a person and/or a property. Such causes of harm might include defective products, faulty installations and errors in services provided. Generally, these three coverages are often sold together as a single Business Owner's Policy, also known as a BOP. Buying these coverages together is generally less expensive than buying each coverage separately. A typical BOP provides liability insurance and protection for business' property but since businesses are so different these need to be specifically tailored to the needs and requirements of each specific business.

Customers may also require specific business type coverages. If a business relies on doing business with major corporations, many of them will require bidders to have Errors and Omissions coverage, a type of professional liability insurance. This coverage helps to protect the business when an action, or failure to take action, in its professional capacity, results in injury or financial damage to a customer and is very important for companies with professionals who give advice, make recommendations, design solutions or represent the needs of others, such as attorneys, accountants, real estate brokers, consultants, software developers, copywriters, Web page designers, or job placement services. Such coverage typically covers the cost of legal defense plus the final judgment, up to a set amount, if the business owner does not win the case.

Additionally, other coverages such as commercial auto coverage and data breach coverage or other types of coverages such as Employment Practices Liability Coverage, Equipment Breakdown Coverage, Data Compromise and Identity Recovery Coverage, Livestock and crop insurance and many others are available for a business owner. As is evident, there are so many different types of policies, limits, coverages and options with need to be match reliability and quickly with the many different types of businesses out there.

Accordingly, it would be desirable to have a system that could provide business owners and agents with efficient, accurate and comprehensive coverage recommendations and selections in real time that reflect the current and relevant state of risk concern for each respective business.

### SUMMARY

In an embodiment, a system for recommending products and coverages for business insurance utilizing crowd sourced data includes at least one processor; a memory coupled to the at least one processor; and one or more programs, wherein the one or more programs are stored in the memory and configured to be executed by the at least one processor, the one or more programs including instructions for: receiving business specific information and risk concern information from a requesting user; supplementing the business specific information from at least one of a location based information service and a business information website; performing analysis of crowd sourced data with similar business specific information and risk concern information as the requesting user; selecting based on the analysis one or more products and coverages for the requesting user; and providing recommended coverages and products for display to the requesting user.

In an embodiment, a computer system for processing small business owner products and coverages requests in a multi-insurer environment includes a processor coupled to the multi-insurer communications network; and at least one storage device in communication with the processor; the processor configured to: receive product and coverage requests via the multi-insurer communications network from one or more small business owners; determining using a predictive model one or more product and coverage recommendations based on historical crowd sourced data on product selections and risk concerns; formatting in a tiered display configuration the determined one or more product and coverage recommendations; and binding the one or more product and coverage recommendations via the multi-insurer communication network to the small business owner.

In an embodiment, a computer-implemented method for processing crowd sourced insurance and risk data to recommend business insurance coverages to at least one user includes receiving, via a communications interface, a plurality of crowd sourced data related to business insurance requests and risk concerns; storing the crowd sourced data related to business insurance requests and risk concerns in a data storage device; configuring an information screen display for receiving business insurance request and risk concern data from at least one requesting user, processing, in a processor, the crowd sourced data business insurance requests and risk concerns to determine one or more business insurance coverage recommendations for the at least one requesting user, wherein processing includes accessing one or more predictive models to determine a correlation between the received business insurance request and risk concern data and the stored crowd sourced data; and configuring for display on a mobile display device the one or more business insurance coverage recommendations, wherein the one or more business insurance coverage recommendations are arranged in a location based configuration for selection by the at least one requesting user.

### BRIEF DESCRIPTION OF THE DRAWINGS

A more detailed understanding may be had from the following description, given by way of example in conjunction with the accompanying drawings wherein:

FIG. 1 shows an exemplary computer architecture that may be used for policy data administration and management;

FIG. 2 shows an exemplary system that may be used for the management of policy data;

FIG. 3 shows exemplary system screen display of the present invention;

FIG. 4 shows exemplary system screen display of the present invention;

FIG. 5 shows exemplary data processing of the present invention;

FIG. 6 shows exemplary system screen display of the present invention;

FIG. 7 shows another exemplary device of the present invention;

FIG. 8 shows an exemplary method of the present invention; and

FIG. 9 shows an exemplary method of the present invention.

### DETAILED DESCRIPTION

Disclosed herein are processor-executable methods, computing systems, and related technologies for the administration, management and processing of real time business insurance products and coverages for customers and agents based on an analysis of crowd sourced perceived risk data and historical purchasing patterns of businesses with similar locations and industry/service classifications. Generally a business owner or agent will provide some basic risk classification and location information such as via a brief online survey on the types of risks that they are concerned about. The business owner's inputs are matched with historical perceived risk data and purchasing habits of businesses with similar characteristics, and recommended coverages and products are provided to the owner or agent. Direct customers, by receiving “agent-like” business insurance product and coverage recommendation based on crowd sourced data for similar businesses and agents, benefit by being provided real time product recommendations that are currently relevant for their customers in view of their industry peers. Recommendations may be provided to the business owners in a variety of formats and arrangements tailored to that business owner's needs and risk concerns such as by locality or geographic area, by sales volumes or company size or by other factors that intelligently link the businesses together. The present invention, in embodiments, is a real time dynamic system that progressively collects information from a variety of customers in real time and then also pushes recommendation data back to each new successive customer based on the historical viewing and purchasing patterns of prior customers and their risk concerns.

“Crowd sourced data,” as used herein, means data that is collected in a process of requesting a members of a group, such as business owners who apply for or inquire about business insurance, to provide information or respond to one or more questions, and receiving information and responses from the members of the group. The requesting and the receipt of information and responses may be carried out through any electronic arrangement. The persons requested to reply may exclude insurance company employees and consultants.

The term “small business” as used herein designates a business having no more than a maximum number of full-time equivalent (FTE) employees. The maximum number may be in the range from 15 to 500, and may be 50, 100 or 200, by way of non-limiting example.

The term “small business owner” as used herein designates any owner of a full or partial equity interest in a small business.

The term “business insurance” includes any insurance product, policy or coverage for use by a business. The term “business insurance” excludes any form of personal insurance, such as homeowners insurance, personal auto insurance, renters insurance, and personal umbrella insurance.

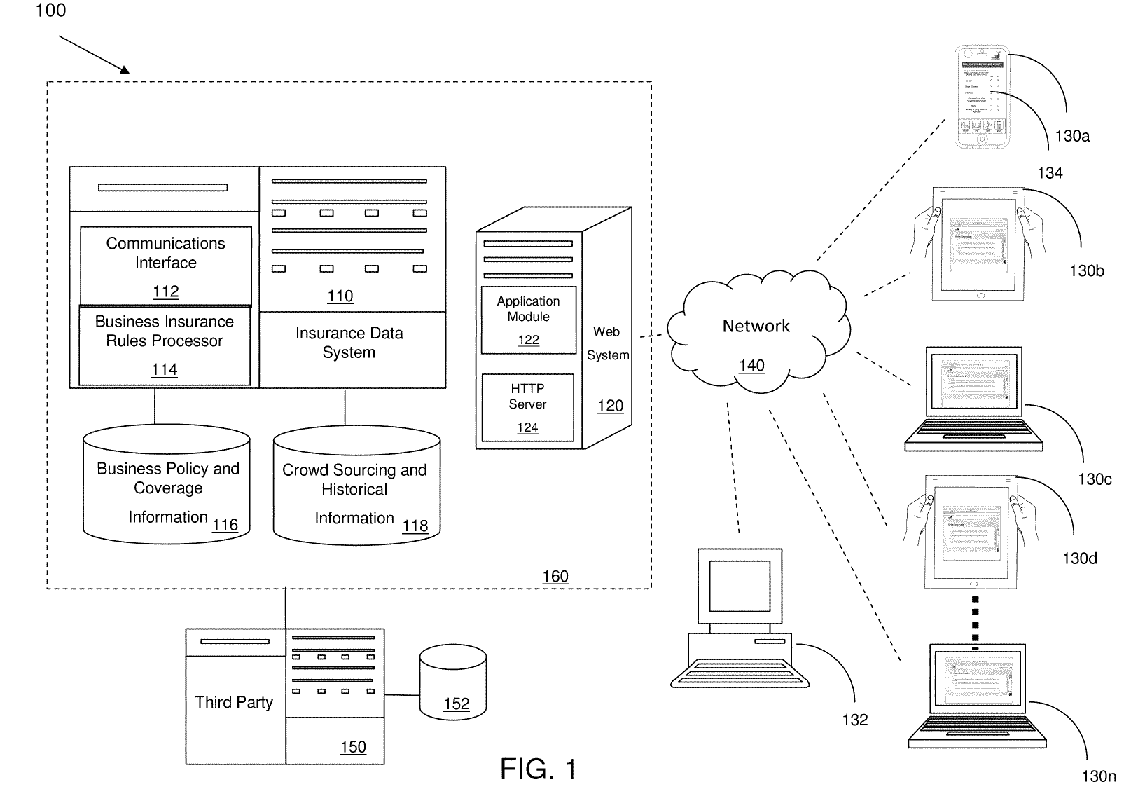

FIG. 1 shows an example system architecture 100 that may be used for the administration and management of real time business insurance products and coverages recommendations such as for products and coverages such as Property Insurance, Business Income Coverage, Business Owner's Policy, Comprehensive General Liability, Bodily Injury Liability, Property Damage, Liability, Operations Exposures, Advertisers Personal, Fire Legal Liability, Medical Payments, Commercial Auto, Data Breach, Umbrella Insurance, Fidelity and Surety Bonds and Workers Compensation among others for a variety of different types of businesses. The example architecture 100 may include a single carrier or a multi carrier based insurance data system or insurance management platform 110, a web system 120, crowd sourced client/user devices 130a-n, a requesting user device 132, a network 140, and at least one third party data system 150 and third party database 152 comprising an insurance data processing subsystem 160. In one embodiment, customer or agent devices 130a-n, requesting user device 132 and insurance subsystem 160, are in communication via a network 140. Insurance data processing subsystem 160 shown in FIG. 1 is an embodiment of a subsystem that might be implemented solely within the corporate office headquarters of a financial services/insurance company or be an aggregation of one or more other subsystems including one or more partner, third party administrator and/or vendor subsystems to allow communications and data transfer between the insurance company and business owner insurance customers and business insurance agents. Data transferred through network 140 to insurance subsystem 160 may pass through one or more firewalls or other security type controls implemented within web system 120. The firewall allows access to network 140 only through predetermined conditions/ports. In another embodiment, the firewall restricts the Internet IP addresses that may access web system 120.

Referring still to FIG. 1, the insurance data system 110 may include a communications interface 112, a business insurance rules processor 114, a business policy and coverage information database 116 and crowd sourcing and historical information database 118. The business insurance rules processor 114 may include one or more business rules and one or more predictive models in conjunction with one or more software modules or objects and one or more specific-purpose processor elements to perform the processing required by the present invention such as for determining appropriate business insurance policy and coverage recommendations, processing crowd sourced and historical based purchasing and risk data such as may be provided via client devices 130a-n, determining policy and coverage option selections, and configuring policy and coverage selections for display. Business rules governing business policy option selections, such as what policies to select and display, and rules correlating policy and coverage selections that may be related to weather and other external factors may also be included. For example, if a weather forecast shows a number of seasonal hurricanes forecasted for a certain geographical area, then rules may be implemented to select certain coverages such as flood coverage for recommendation to supplement those policies and coverages selected based on analysis of real time crowd sourcing data and historical purchasing patterns. The system may proactively poll for such weather events or social media discussion and predictively serve up certain policies or coverages to users. The system may be configured to conduct keyword, phrase or other suitable searches of databases of weather, current events data, social media discussion data, including original source data and extracted databases, and apply business rules, such as business rules associating policies to keywords and/or phrases to the search results to identify policies or coverages. Economic forecasting and trending may also be used in addition to or instead of other factors such as weather. For example, if economic forecasts or trends, whether for a national economy, for a regional or area economy, or for a relevant business segment, are negative for the foreseeable future or for a selected period in the future, for example as a result of analysis incorporated in the forecasts or trends of currency fluctuations or job data, the system may recommend business interruption or business income coverage more readily due to the forecasting. Additionally, business and industry trend studies and data may also be used to determine appropriate products and coverages for the user. For example, if industry trend studies show that certain categories of businesses are at risk for data breaches, then this may be factored in addition to, instead of or to change the weighting of the product and coverage recommendations.

The business policy and coverage information database 116 may store information, data and documents that relate to corporate policies such as those related to Code of Conduct, Information Protection, Equal Employment Opportunity/Affirmative Action, Sexual and Other Unlawful Harassment, Drug Free Workplace/Prohibited Substances, Trading in Securities, Electronic Device Usage, Regulatory Affairs and Quality Assurance, Employee, Customer and Vendor Privacy, Improper Payments, Business Resiliency, Procurement and Operational Risk Management as well as many other areas. Crowd sourcing and historical information database 118 may store information, data and documents that relate to crowd sourced perceived risk data and historical purchasing patterns of businesses with similar locations and industry/service classifications. Business policy and coverage information database 116 and crowd sourcing and historical information database 118 may be spread across one or more computer-readable storage media, and may be or include one or more relational databases, hierarchical databases, object-oriented databases, one or more flat files, one or more spreadsheets, and/or one or more structured files. Business policy and coverage information database 116 and crowd sourcing and historical information database 118 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

Communication between the insurance data system 110 and the other elements in the example architecture 100 of FIG. 1 may be performed via the communications interface module 112 interacting within intranet 160. The insurance data system 110 may also access third party systems 150 and third party data 152 via network 140. For example, insurance data system 110 may interface with computer systems associated with one or more third party sites to receive data from one or more entities like weather sites or data repositories, small business information sites, e-commerce sites, utility provider sites, social networks, blogs and other varieties of sites in the Internet.

Referring still to FIG. 1, web site system 120 may provide a web site that may be accessed directly by a user such as a business owner or a business insurance agent operating user client devices 130a-n and requesting user device 132. In certain embodiments, crowd sourced user client devices 130a-n and requesting user device 132 can include, but is not limited to cellular telephones, other wireless communication devices, personal digital assistants, pagers, laptop computers, tablet computers, smartphones, other mobile display devices, or combinations thereof. In the present invention, crowd sourced client devices 130a-n and requesting user device 132 may communicate with the web site system 120 that may be operated by or under the control of an insurance entity or other third party entity such as an outsourced type entity or third party administrator type entity. The web site system 120 may generate one or more web pages for access by client devices 130a-n and requesting user device 132, and may receive responsive information from client devices 130a-n such as certain requested policy information. The web site system 120 may then communicate this information to the insurance data system 110 for processing via communications interface 112.

In operation, client devices 130a-n and requesting user device 132 may be used to prompt users to provide business specification information, such as location and business type or classification information, services identification information, number of employee information, number of locations information, annual, quarterly or monthly revenue information, and to provide information relating to perceived risks or risk concerns associated with businesses, and to receive business and risk information, including perceived risk information or risk concern information, select, access and view one or more business insurance products and coverages in accordance with crowd sourced perceived risk data and historical purchasing patterns of businesses with similar location and industry/service classifications, and/or other similar characteristics, such as service identifications, periodic revenue information or employee counts. Selection via client devices 130a-n and requesting user device 132 may be accomplished via a touch-sensitive touch screen that provides an input interface and an output interface between client device 130a-n and the client or user. Client devices 130a-n and requesting user device 132 display visual output to the user for manipulation by the user. The visual output may include checkboxes, radio buttons, graphics, text, icons, video, and any combination thereof. The touch screen may display one or more graphics within user interface displayed on devices 130a-n and 132.

The web site system 120 may include an web application module 122 and a HyperText Transfer Protocol (HTTP) server module 124. The web application module 122 may generate the web pages that make up the web site and that are communicated by the HTTP server module 124. Web application module 122 may be implemented in and/or based on a technology such as Active Server Pages (ASP), PHP: Hypertext Preprocessor (PHP), Python/Zope, Ruby, any server-side scripting language, and/or any other appropriate technology.

The HTTP server module 124 may implement the HTTP protocol, and may communicate HyperText Markup Language (HTML) pages and related data from the web site to/from client devices 130a-n and 132 using HTTP. The HTTP server module 124 may be, for example, a Sun-ONE Web Server, an Apache HTTP server, a Microsoft Internet Information Services (IIS) server, and/or may be based on any other appropriate HTTP server technology. The web site system 120 may also include one or more additional components or modules (not depicted), such as one or more switches, load balancers, firewall devices, routers, and devices that handle power backup and data redundancy.

Referring still to FIG. 1, one or more of the client devices 130a-n such as client device 130a may include a web browser module 134, which may communicate data related to the web site to/from the HTTP server module 124 and the web application module 122 in the web site system 120. The web browser module 134 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 134 may implement Rich Internet Application (RIA) and/or multimedia technologies such as Adobe Flash, Microsoft Silverlight, and/or other technologies. The web browser module 134 may implement RIA and/or multimedia technologies using one or web browser plug-in modules (such as, for example, an Adobe Flash or Microsoft Silverlight plugin), and/or using one or more sub-modules within the web browser module 134 itself. The web browser module 134 may display data on one or more displays that are included in or connected to the client device 130a, such as a liquid crystal display (LCD) display, organic light-emitting diode (OLED) display, touch screen or monitor. The client device 130a may receive input from the user of the client device 130a from input devices (not depicted) that are included in or connected to the client device 130a, such a mouse or other pointing device, or a touch screen, and provide data that indicates the input to the web browser module 134.

The example architecture 100 of FIG. 1 may also include one or more wired and/or wireless networks within subsystem 160 via which communications between the elements and components shown in the example architecture 100 may take place. The networks may be private or public networks, cloud or shared networks and/or may include the Internet.

Each or any combination of the components/modules 112, 114, 122, and 124 shown in FIG. 1 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules 112, 114, 122, and 124 may perform functionality described later herein.

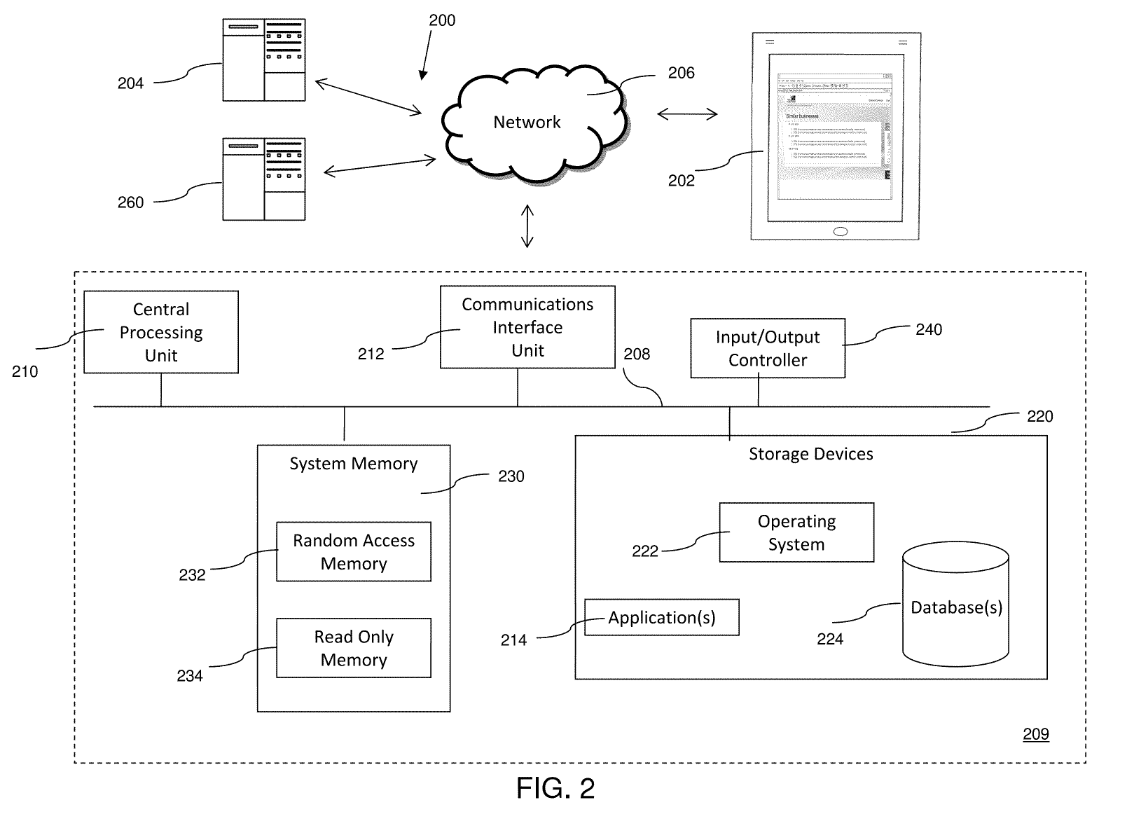

Referring to FIG. 2, an exemplary computer system 200 for use in an implementation of the invention will now be described. Computer system 200 may be configured to perform business product and coverage data processing and management for one or more business owners and/or agents 202. System 200 may include a business product and coverage data system 204, a network 206 and an insurance administration system 209. In embodiments of the present invention, business policy and coverage data system 204 is responsible for the processing of business owner or agent requests for business insurance recommendations utilizing crowd sourced perceived risk data and historical purchasing patterns of businesses with similar location and industry/service classification. In insurance administration system 209, a central processing unit or processor 210 executes instructions contained in programs such as policy management application program 214, stored in storage devices 220. Processor 210 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 220 may include suitable media, such as optical or magnetic disks, fixed disks with magnetic storage (hard drives), tapes accessed by tape drives, and other storage media. Processor 210 communicates, such as through bus 208 and/or other data channels, with communications interface unit 212, storage devices 220, system memory 230, and input/output controller 240. System memory 230 may further include non-transitory computer-readable media such as a random access memory 232 and a read only memory 234. Random access memory 232 may store instructions in the form of computer code provided by application 214 to implement the present invention. System 200 further includes an input/output controller 240 that may communicate with processor 210 to receive data from user inputs such as pointing devices, touch screens, and audio inputs, and may provide data to outputs, such as data to video drivers for formatting on displays, and data to audio devices.

Storage devices 220 are configured to exchange data with processor 210, and may store programs containing processor-executable instructions, and values of variables for use by such programs. Processor 210 is configured to access data from storage devices 220, which may include connecting to storage devices 220 and obtain data or read data from the storage devices, or place data into the storage devices. Storage devices 220 may include local and network accessible mass storage devices. Storage devices 220 may include media for storing operating system 222 and mass storage devices such as storage 224 for storing data related to business insurance products and coverage, crowd sourcing data and historical purchasing data.

Communications interface unit 212 may communicate via network 206 with other financial services/insurance company computer systems such as business product and coverage data system 204 as well as other servers, computer systems of remote sources of data, and with systems for implementing instructions output by processor 210. Business product and coverage data system 204 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. Network 206 may be or include wired or wireless local area networks and wide area networks, and over communications between networks, including over the Internet.

One or more public cloud, private cloud, hybrid cloud and cloud-like networks may also be implemented, for example, to handle and conduct processing of one or more transactions or processing of the present invention. Cloud based computing may be used herein to handle any one or more of the application, storage and connectivity requirements of the present invention. For example one or more private clouds may be implemented to handle crowd sourcing processing and storage of the present invention. Furthermore, any suitable data and communication protocols may be employed to accomplish the teachings of the present invention.

With reference still to FIG. 2, communications interface 212 is used for receiving user or a requesting user's data related to the user or requesting user's policy requests made via the Web. Computer processor 210 executes program instructions, such as program instructions provided by application 214 to receive, via the communications interface 212, third party data, social network data and other related information. Database 224 may include transaction data such as historical data from the user or other third parties.

Insurance administration system 209 may also be in communication with a policy holder reporting computer system 260 that is configured to receive data relating to policies from policy administration computer system 209. Policy holder reporting computer system 260 is configured to format documents related to policies for printing. In an embodiment, policy holder reporting computer system 260 may be configured to store formatted documents as image data files. Policy holder reporting computer system 260 may be in communication with or include data storage devices storing templates of policy-related documents, including policy contracts, riders, and correspondence directed to policy owners, such forms of notifications of renewals, premium changes and changes in policy terms. A template may be in the form of a document in a digital file format with fields designated for addition of data particular to the policy, such as name of insured entity, address of insured entity, address of insured property, type of construction of insured property, area of insured property, permitted uses of insured property, industrial classification of insured entity, VIN, make, model, year and/or mileage of covered vehicles, coverage limits, policy effective dates, names of additional insured individuals or entities, premium amounts, references to riders, and other fields. Policy holder reporting computer system may be configured to, responsive to receipt of data relating to policies from policy administration computer system 209, access stored rules for selection of one or more of the stored templates, select one or more of the templates in accordance with the rules, populate the templates with data particular to policies, and create formatted files for printing and mailing of policy documents to policy holders, or for providing of image files to policy holders. Policy owner reporting computer system may thus be configured to generate business insurance policies and policy documents, such as policy contracts, correspondence to officers and owners of insured entities, riders and other documents.

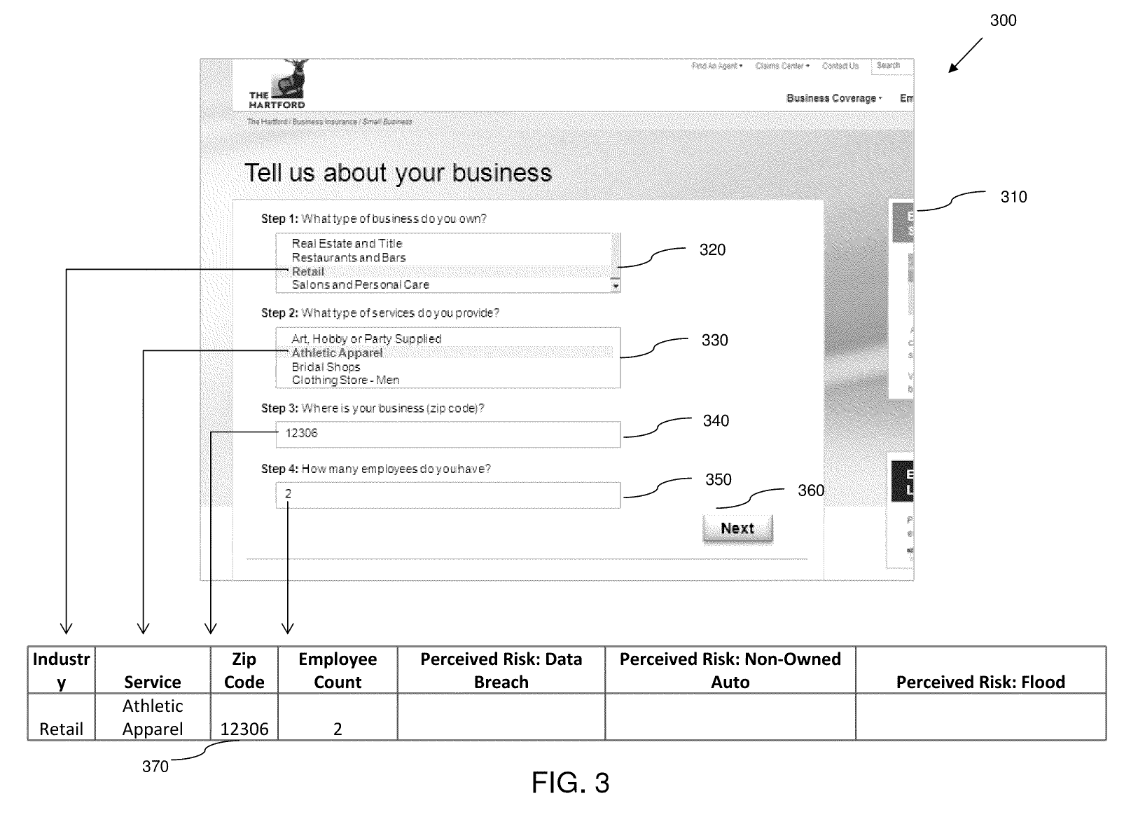

FIG. 3 illustrates an exemplary screen configuration 300 of a business insurance coverage recommendation system as discussed with respect to FIGS. 1 and 2. Screen 300 is configured to interface with a requesting user such as a small business owner for requesting and receiving business data related to the small business owner's specific business. Screen 300 may be configured with one or more input/selection areas such as areas or fields 320 and 330 for collecting business specific information, including business classification information from the requesting user. Screen 300 may also be configured to solicit and collect business specification information such as information related to the business's location such as in area 340 where a zip code or other location identifying information may be collected and a number of employees area or field 350. Other fields may be available and included such as one related to the user's industrial classification, typically from a standardized industrial classification system such as the Standard Industrial Classification (SIC) system or North American Industrial Classification System (NAICS). The industrial classifications may be inputted by the requesting party or may be provided and accessed in real time by a third party, such as a vendor like Experian or Dun and Bradstreet, and/or assigned by the insurance company using web crawling techniques or predictive modeling. Referring still to FIG. 3, information and data from form 310 may be compiled or tabulated such as in table 370 for further processing and storage by a system processor and database of the present invention.

In an embodiment where the industrial classifications are provided by a third party, the insurance company may review the assigned classifications and confirm or adjust them. Additionally, more than one industrial classification may be assigned to an entity or user. For example, a bakery may fall under at least SIC codes 2050 (Bakery Products) and 2052 (Cookies and Crackers) if the bakery makes cookies as well as cakes and pies. Input of information in web form 310 may also initiate an automated classification process where a computerized predictive model processes the information to determine at least one industrial classification for the entity or user. The industrial classification may be a standardized classification code, such as a NAICS, SIC, or ICB code. Depending on available data and desired resolution, the computerized predictive model may return industry, supersector, sector, or subsector classifications. The computerized predictive model may first select one or more industries, then select one or more supersectors within the selected industries, and so forth, collecting additional data to achieve more specific classifications. The computerized predictive model may also calculate a value, such as a confidence level or likelihood, indicating how well a particular industrial classification describes the entity or user.

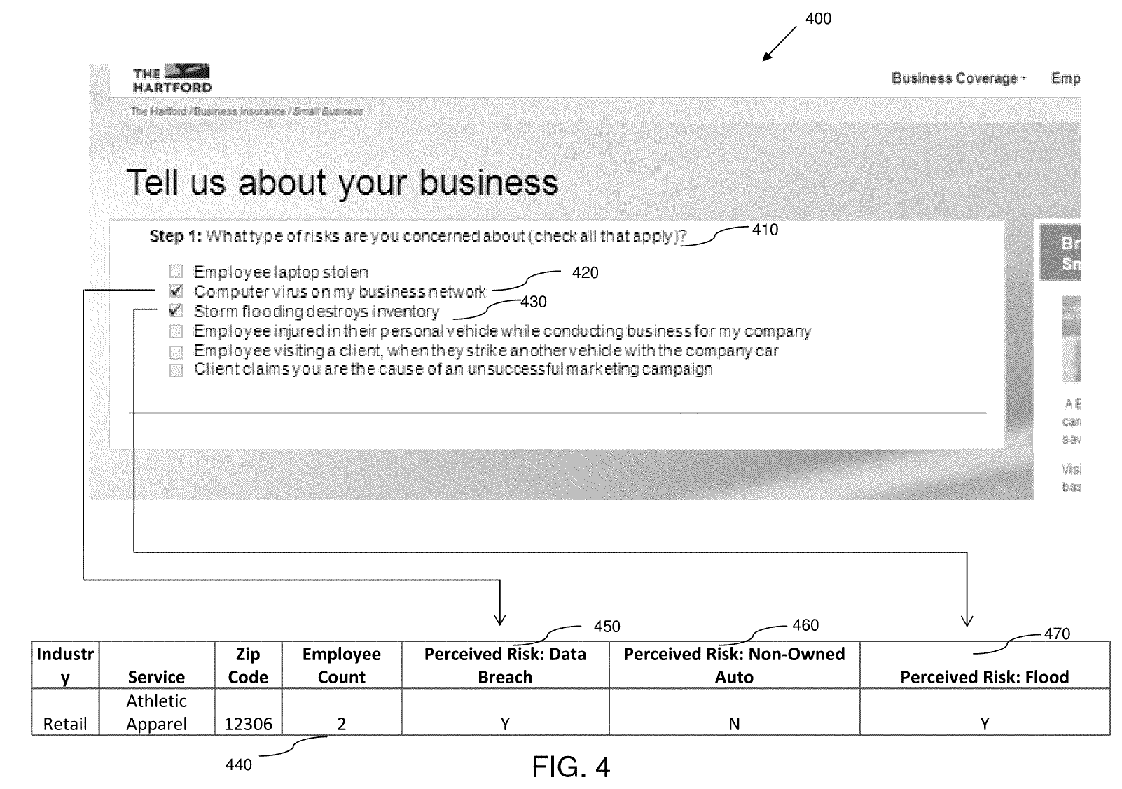

FIG. 4 illustrates another exemplary screen configuration 400 of a business insurance coverage recommendation system as discussed with respect to FIGS. 1 and 2. Screen 400 is also configured to interface with a requesting user such as a small business owner for requesting and receiving business risk data related to the small business owner's specific business. Screen 400 may be configured with one or more input/selection areas such as areas or field 410 for collecting business risk information, or information on perceived risks, from the requesting user. In this exemplary embodiment, the requesting user selects one or more choices in field 410 such as choices or selections 420 and 430. Selections 420 and 430 are input into table 440 with the specific sections being recorded into fields 450, 460 and 470. In this exemplary embodiment, the requesting user has indicated that a data breach risk 450 is a perceived risk, that non owned auto 460 is not a perceived risk and that flood 470 is a perceived risk.

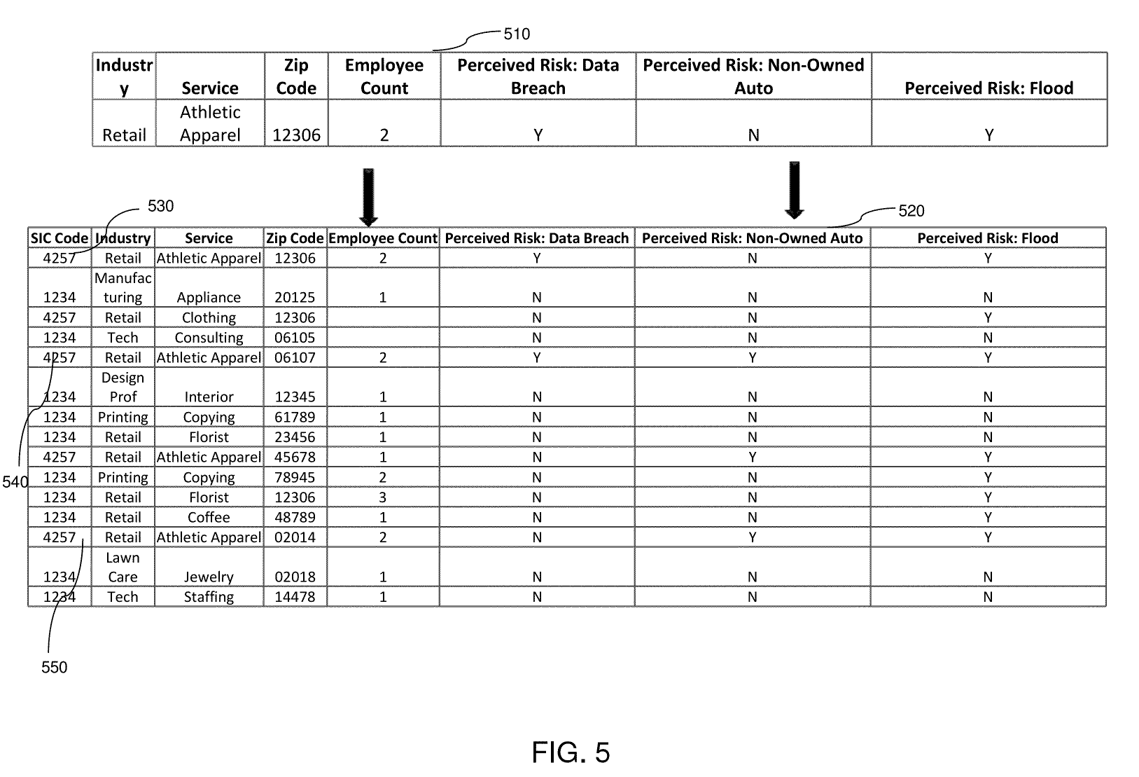

FIG. 5 illustrates an exemplary diagrammatic processing analysis of the present invention utilizing business and risk information received as illustrated in FIGS. 3 and 4. Information and data collected from a requesting user such as a small business owner related to the owner's specific business data and risk information 510 is correlated to certain historical business and risk data 520 using one or more regression analysis techniques and/or predictive models. For example, a predictive model utilized by the present invention may be formed from neural networks, linear regressions, Bayesian networks, Hidden Markov models, or decision trees. Preferably, the predictive model is trained on a collection of data known about prior historical business insurance customer data and their corresponding perceived risks, or risk concerns, so that a certain requesting business owner with current data business and risk information 510 may be associated with certain historical customers having similar business characteristics and risk concerns, such as shown in rows 530, 540, and 550 where the customers have similar business type, employee count and location characteristics among others. In various embodiments, the particular data parameters selected for analysis in the training process are determined by using regression analysis or other statistical techniques, such as posterior probability modeling, known in the art for identifying relevant variables in multivariable systems. The predictive model may also be iteratively trained using the historical purchasing patterns and risk data with current purchasing patterns and risk data from each successive customer so that the model is continuously updated in real time based on the viewing and purchasing patterns and risk data from each new customer.

Here in FIG. 5, the requesting user has been classified in the retail industry for services in athletic apparel and zip code 12306 with 2 employees and has indicated concern with data breach and flood. Application of the predictive model to the businesses among historical users in a database returns, as those historical users having highest values of similarity, the exemplary historical users, having similar business characteristics and risk concerns, shown in rows 530, 540 and 550. Purchase histories of coverages selected by the historical users shown in rows 530, 540 and 550 are processed and mapped as appropriate to the requesting user, with greater weighting being provided with respect to businesses that have purchased coverages related to data breach and flood.

In one embodiment, the risk concerns and thresholds may be determined based on the historical business data and risk information using a predictive model. The predictive model generally takes into account a large number of parameters such as SIC code, industry, service, location such as zip code or geographical area, employee count, and perceived risk for data breach, non-owned auto, flood among others. The predictive model in various implementations, may include one or more of neural networks, Bayesian networks (such as Hidden Markov models), expert systems, decision trees, collections of decision trees, support vector machines, or other systems known in the art for addressing problems with large numbers of variables. Preferably, the predictive model is trained on prior data and outcomes known to the insurance company. The specific data and outcomes that are analyzed by the predictive model vary depending on the desired functionality of the predictive model. In particular, depending on the insurance product or coverage option which the predictive model is used to determine for the requesting user, the specific data and outcomes selected for training the predictive model are determined by using regression analysis and/or other statistical techniques known in the art for identifying relevant variables in multivariable systems. The specific data and outcomes can be selected from any of the structured data parameters stored in databases 116 and 118 such as illustrated in FIG. 1, whether the parameters were input into the system originally in a structured format or whether they were extracted from unstructured text.

In embodiments, in response to receipt of business specific information, values of the received business specific information may be employed in algorithms implemented by the predictive model to evaluate similarity of business entities reflected in the databases. By way of example, business specific information including zip code, SIC code, and number of employees, and risk concern data, is received. For each zip code, a similarity value is accessed or calculated. For each SIC code, a similarity value is accessed or calculated. For each value of number of employees, a similarity value is accessed or calculated. For each type of crowd-sourced risk concern data, a similarity value is accessed or calculated. The similarity values may be developed during training of the predictive model, for example. Weights, which may be determined in training of the predictive model, may be assigned to each similarity value. An algorithm may be employed applying the weights to the similarity values, and summing the resulting weighted similarity values to determine a similarity factor for each business in the database. The similarity factors may be normalized. Businesses meeting a threshold similarity factor may be designated as similar businesses. Crowd sourced risk concern data obtained from the thus-determined similar businesses may be displayed to the user. It will be appreciated that the business specific information is merely exemplary, as is the algorithm described above. One or more similarity values may be used as threshold values, by way of example.

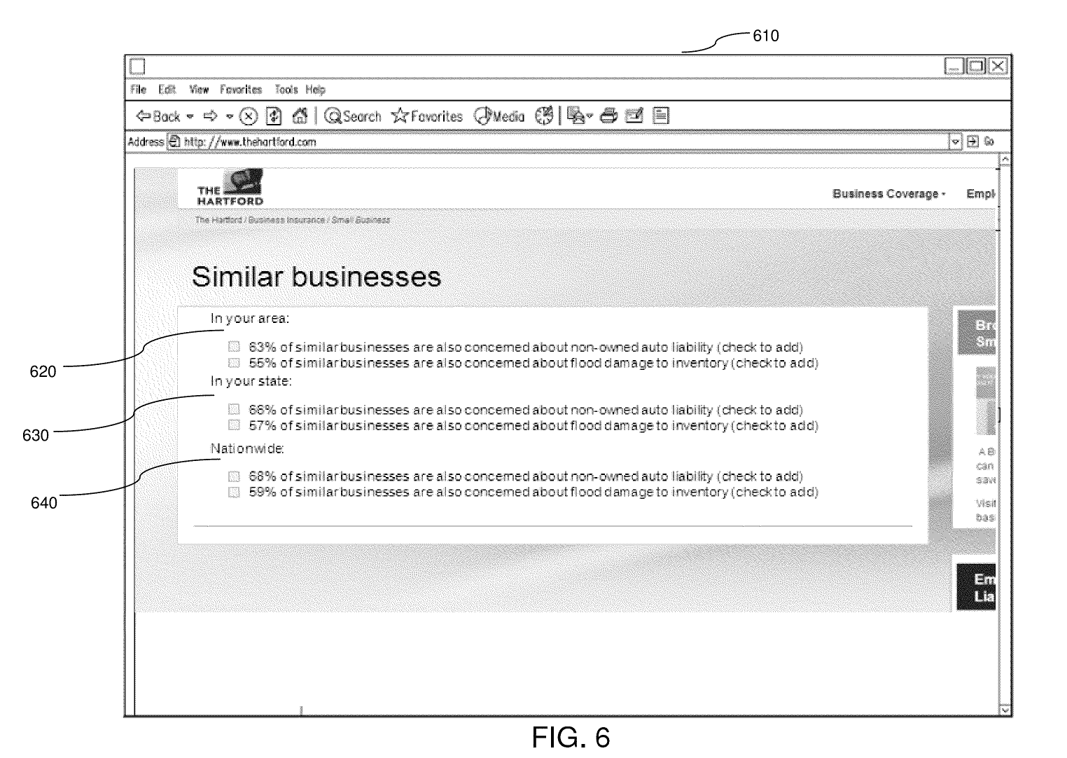

FIG. 6 illustrates an exemplary screen 610 that provides a summary screen to a user related to business and risk information for similar businesses to the user's business. A user may access screen 610 utilizing a portable computing device such as a smartphone or tablet computing device for viewing and accessing the information shown in screen 610. Screen 610 may include input/selection areas 620, 630 and 640 for selecting inputs related to recommended product and coverage selections that correlated to the business of the user. For example, input/selection areas 620, 630 and 640 may be organized in a tiered arrangement such a geographically tiered arrangement or configuration such as three tiers of geographically increasing scope, such as an area based selection field 620, a state based selection field 630 and a nationwide based selection field 640. Alternatively, input/selection areas 620, 630 and 640 may be organized in a graduated format or graduated arrangement such as by increasing or decreasing company size, increasing or decreasing thresholds of sales or profits figures, increasing or decreasing years in business, or other increasing or decreasing levels of business specific traits or business specific factors. For example, a combination of factors or traits may be used to provide the tiered arrangement such as a business with 20-50 employees with one place of business in a first tier, a business with 51-100 employees with one or two places of business in a second tier, and a business with 101-200 employees with two to three places of business may be used. Additionally, input/selection areas 620, 630 and 640 may be arranged to allow the user to select certain product and coverage options based on a sales level of $500,000, $1,000,000 and over $5,000,000. Upon selecting one or more of the input/selection areas 620, 630 and 640, the user is then provided a quote for a business insurance product and/or coverage that corresponds to the selection. For example, if the user selects in area 640 the selection “66% of similar business are also concerned about non-owned auto liability”, the user will be provided the option to see more information and/or be provided a quote for coverage related to non-owned auto liability at similar options and limits. The quote may be either bindable or non-bindable.

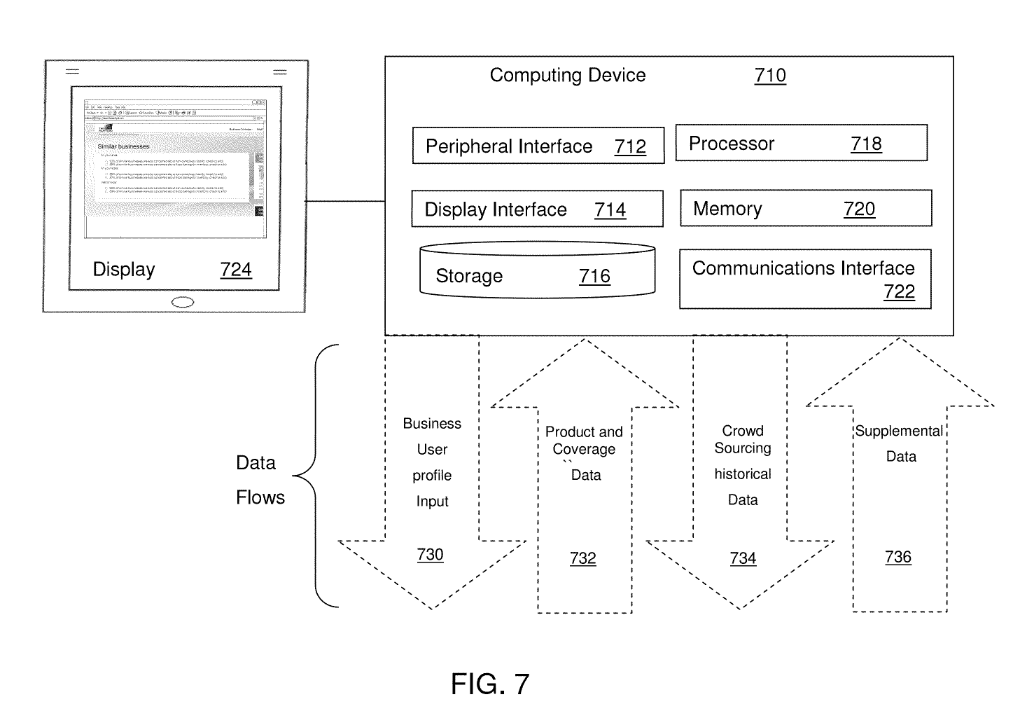

FIG. 7 shows an example computing device 710 that may be used to implement features describe above for processing, selecting and displaying business product and coverage recommendations in accordance with the present invention. The computing device 710 may include a peripheral device interface 712, display device interface 714, a storage device 716, a processor 718, a memory device 720, and a communication interface 722. Computing device 710 may be coupled to a display device 724, which may be separately coupled to or included within the computing device 710. In operation, computing device 710 is configured to receive and transmit a number of data flows via communications interface 722 including, for example, business user profile data 730, product and coverage data 732, crowd sourcing historical data 734 and supplemental data 736.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 700.

The memory device 720 of FIG. 7 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

An instance of the computing device 710 of FIG. 7 may be configured to perform any feature or any combination of features described above as performed by user devices 130a-n and 132 as described with respect to FIG. 1. In such an instance, the memory device 720 and/or the storage device 716 may store instructions which, when executed by the processor 718, cause the processor 718 to perform any feature or any combination of features described above as performed by the web browser module 134. Alternatively or additionally, in such an instance, each or any of the features described above as performed by the web browser module 134 may be performed by the processor 718 in conjunction with peripheral device interface 712, display device interface 714, and/or storage device 716, memory device 720, and communication interface 722.

Alternatively or additionally, an instance of the computing device 710 may be configured to perform any feature or any combination of features described above as performed by the insurance data system 110. In such an instance, the memory device 720 and/or the storage device 716 may store instructions which, when executed by the processor 718, cause the processor 718 to perform any feature or any combination of features described above as performed by the interface module 112 and/or the business rules module 114. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the web application module 122 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 7 shows that the computing device 710 includes a single processor 718, single memory device 720, single communication interface 722, single peripheral device interface 712, single display device interface 714, and single storage device 716, the computing device may include multiples of each or any combination of these components 712, 714, 716, 718, 720, and 722 and may be configured to perform analogous functionality to that described above.

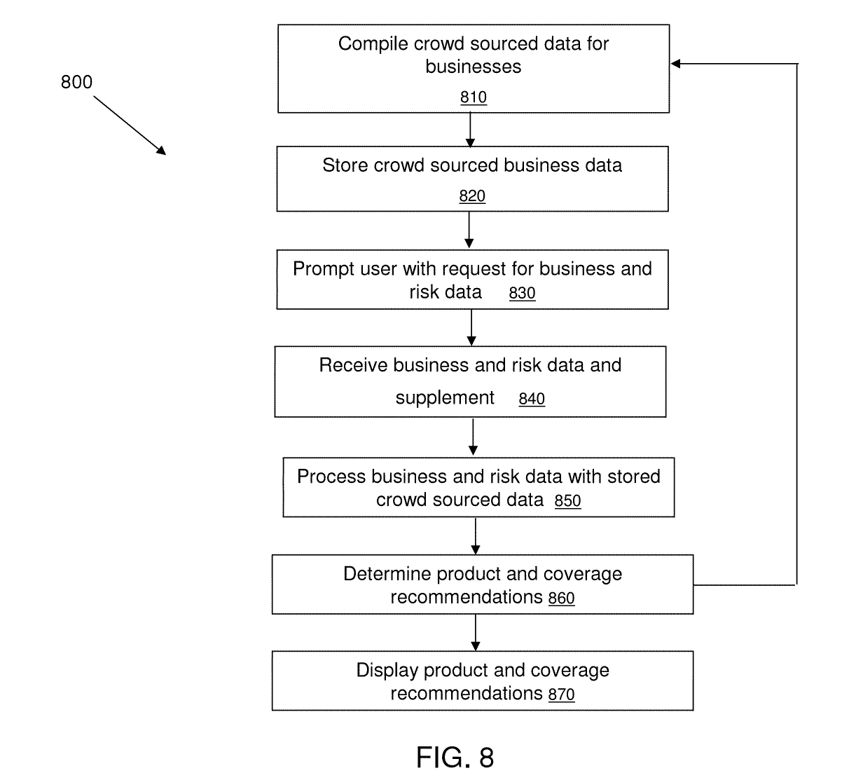

FIG. 8 shows an example process flow diagram illustrating a method 800 for administering a business insurance recommendation process using the example architecture 100 of FIGS. 1 and 2. The method 800 of FIG. 8 may begin by having the system 100 of FIG. 1, compile crowd sourced data for businesses, step 810. The crowd sourced data may be compiled from a number of statistically significant transactions that have occurred in a single and a multi-insurer environment from completed or pending business insurance transactions. The crowd sourced data may include current and historical data related to business insurance requests and perceived risks and risk concerns of business owners. The data is then stored, step 820 such as in a database 224 described in FIG. 2. A user such as a business owner is prompted with a request for a business insurance request and risk concern data associated with their business, step 830 such as an information screen display described with respect to FIGS. 3 and 4. System 100 may then receive the business and risk concern data and supplement as necessary, step 840. The business data may be supplemented by a variety of additional information sources such as an insurance company database, internet searching, third party databases, etc. For example, if a business owner user simply provides their business name, the system may look up other information regarding that specific business using these other information sources. In one embodiment, at least one of a location based information service and a business information website are used to supplement the information such as using location or global positioning information from the user device to determine a location of the user's business. A business information website such as the LinkedIn® information service may also be used to supplement the information provided about the business, such as by providing a requesting user business type by verbal description or industrial classification. Upon receiving the business and risk data, this data is processed along with the stored crowd sourced data, step 850. The system then determines one or more business insurance product and coverage recommendations for the business identified by the user, step 860. The one or more business insurance product and coverage recommendations are configured for display for the user, step 870, such as shown an described with respect to FIG. 6.

One or more steps of method 800 may be implemented as computer program instructions provided on a non-transitory computer readable medium for execution by one or more processors. As used herein, the term “non-transitory computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

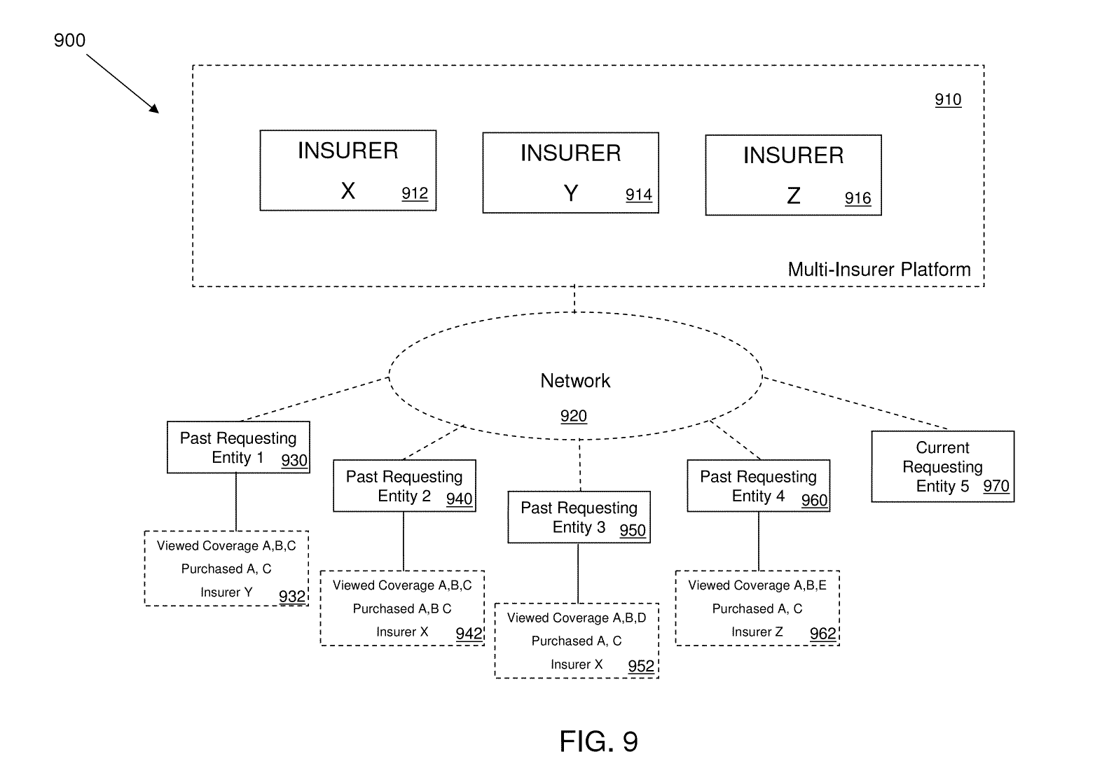

An embodiment of a multi-insurer computing system is shown in FIG. 9. In the illustrated embodiment, a multi-insurer computing platform 910 including a plurality of insurers X, Y Z 912, 914 and 916 is in communication with a network 920. Multi-insurer computing platform 910 may be implemented as one or more servers and may be configured to host one or more web services to communicate with past requesting entities 930, 940, 950, and 960. Past requesting entities 930, 940, 950, and 960 are configured to access network 920 for requesting one or more business insurance product and coverage recommendations 932, 942, 952, and 962 from multi-insurer computing platform 910. Current requesting user 970 is also configured to access network 920 for receiving one or more business insurance product and coverage recommendations based on the crowd sourced transaction histories 932, 942, 952, and 962 of past requesting entities 930, 940, 950, and 960.

Systems of insurers X, Y Z 912, 914 and 916 may be configured to receive requests for business insurance coverage from current requesting user 970 based on business insurance product and coverage recommendations and to generate bindable quotes configured for display on a device of current requesting user 970 via network 920. Current requesting user 970 may accept one of the one or more bindable quotes, thereby binding the coverage with the one of insurer X, Y Z 912, 914, 916 that provided the accepted one of the bindable quotes. The acceptance of the bindable quote may require a premium payment, and the system may be configured to interface with banking and credit card networks as needed to effect a premium payment for the selected and binding coverage.

In various embodiments, multi-insurer computing platform 910 may include any suitable systems that may be configured to host web services or other types of computing resources. For example, in one embodiment a given server system may include a standalone or compartmentalized computer system including one or several processors (e.g., processors compatible with the x86, SPARC™, Power™/PowerPC™, or other suitable instruction set architectures), system memory, networking and/or other peripheral support. Further, in various embodiments server systems may be configured to execute a variety of operating systems (e.g., versions of Microsoft Windows™, Sun Solaris™, Linux, Unix, or other suitable operating systems) as well as applications configured for operation on a particular processor architecture and operating system. In some embodiments, server systems may be referred to as application servers. Generally speaking, the number and specific configuration of server systems may vary depending on the needs of an insurance entity, agents and its customers, and may range from a small number of high-performance systems to a large number of generic systems such a cluster or grid of commodity systems, or any suitable combination thereof. Requesting entities 930, 940, 950, 960 and 970 may operate devices that may include a type of application capable of generating web services requests and receiving responses. In some embodiments, such applications may include a web browser or other type of HTTP-aware interface, although it is contemplated that any type of application such as a custom/proprietary applications, office applications, etc. may be so configured.

Although the methods and features described above with reference to FIGS. 1-9 are described above as performed using the example architecture 100 of FIG. 1 and the exemplary system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-9 may be used alone without the other features and elements or in various combinations with or without other features and elements. Sub-elements of the methods and features described above with reference to FIGS. 1-9 may be performed in any arbitrary order (including concurrently), in any combination or sub-combination.

What is claimed is:

1. A system for recommending products and coverages for business insurance utilizing crowd sourced data, the system comprising:
at least one processor;
a memory coupled to the at least one processor;
and one or more programs, wherein the one or more programs are stored in the memory and configured to be executed by the at least one processor, the one or more programs including instructions for:
receiving business specific information and risk concern information from a requesting user;
supplementing the business specific information from at least one of a location based information service and a business information website;
performing analysis of crowd sourced data with similar business specific information and risk concern information as the requesting user, wherein the crowd sourced data includes current and historical crowd sourced data;
selecting, based on the analysis, one or more coverages for the requesting user; and
providing a tiered display of recommended coverages to the requesting user.

2. The system of claim 1, wherein the recommended coverages include at least two of Business Owner's Policy (BOP), Worker's Compensation Insurance, General Liability Insurance, Commercial Auto Insurance, Property Insurance, Data Breach Insurance, Flood Insurance, Umbrella Insurance and Surety & Fidelity Bonds.

3. The system of claim 1, wherein receiving business specific information and risk concern information from a requesting user comprises prompting for location identifying information and a business type.

4. The system of claim 1, wherein receiving business specific information and risk concern information from a requesting user comprises prompting for a services identification and a number of employees.

5. The system of claim 1, wherein supplementing the business specific information from at least one of a location based information service and a business information website comprises accessing additional information about the requesting user business type.

6. The system of claim 1, wherein receiving risk concern information comprises receiving information on perceived risks by the requesting user.

7. The system of claim 6, wherein the perceived risks comprise at least one of data breach, non owned auto and flood.

8. The system of claim 1, wherein performing analysis comprises using at least one of weather forecasts, economic forecasts and industry trends.

9. The system of claim 1, wherein performing analysis utilizes one or more of a neural networks, linear regressions, Bayesian networks, Hidden Markov models, or decision trees.

10. The system of claim 1, further comprising providing a bindable quote for the recommended coverages.

11. The system of claim 10, further comprising assigning the requesting user to an industrial classification in accordance with one of a Standard Industrial Classification (SIC) system or a North American Industrial Classification System (NAICS).

12. The system of claim 1, wherein providing recommended coverages for display to the requesting user comprises displaying the recommended coverages in a tiered arrangement configured in a graduated arrangement.

13. The system of claim 12, wherein the tiered arrangement is configured by area, state and nation.

14. The system of claim 12, wherein the tiered arrangement is configured by a business specific trait.

15. A computer system for processing small business owner coverages requests in a multi-insurer environment comprising:
a processor coupled to the multi-insurer communications network; and
at least one storage device in communication with the processor;
the processor configured to:
receive product and coverage requests via the multi-insurer communications network from one or more small business owners;
determining using a predictive model one or more product and coverage recommendations based on historical crowd sourced data on product selections and risk concerns;
formatting in a tiered display configuration the determined one or more product and coverage recommendations; and
binding the one or more product and coverage recommendations via the multi-insurer communication network to the small business owner.

16. The system of claim 15, wherein the formatting in a tiered display configuration the determined one or more product and coverage recommendations comprises formatting the determined one or more product and coverage recommendations in a tiered location-based configuration.

17. The system of claim 15, wherein determining using a predictive model one or more product and coverage recommendations comprises using at least one of a weather forecast and an economic forecast to determine the one or more product and coverage recommendations.

18. A computer-implemented method for processing crowd sourced insurance and risk data to recommend business insurance coverages to at least one user comprising:
receiving, via a communications interface, a plurality of crowd sourced data related to business insurance requests and risk concerns;
storing the crowd sourced data related to business insurance requests and risk concerns in a data storage device;
configuring an information screen display for receiving business insurance request and risk concern data from at least one requesting user,
processing, in a processor, the crowd sourced data business insurance requests and risk concerns to determine one or more business insurance coverage recommendations for the at least one requesting user, wherein processing includes accessing one or more predictive models to determine a correlation between the received business insurance request and risk concern data and the stored crowd sourced data; and
configuring for display on a mobile display device the one or more business insurance coverage recommendations, wherein the one or more business insurance coverage recommendations are arranged in a location based configuration for selection by the at least one requesting user.

19. The computer-implemented method of claim 18, wherein the location based configuration includes at least three tiers of increasing geographic scope.

20. The computer-implemented method of claim 18, wherein the one or more predictive models use at least one of a weather forecast, an economic forecast and an industry trend study.
